(19) United States
(12) Patent Application Publication
(10) Pub. No.: US 2002/0061758 A1
(43) Pub. Date: May 23, 2002

(54) Mobile wireless local area network system for automating fleet operations

(75) Inventors: Gary A. Zarlengo, Niwot, CO (US); Gordon Edward Hardman, Boulder, CO (US); John Randall Tuttle, Boulder, CO (US); John W. Pyne, Erie, CO (US)

Correspondence Address: PATTON BOGGS, PO BOX 270930, LOUISVILLE, CO, 80027, US

(73) Assignee: Crosslink, Inc.

(21) Appl. No.: 09/996,027

(22) Filed: Nov. 15, 2001

Related U.S. Application Data
(60) Provisional application No. 60/249,556, filed on Nov. 17, 2000.

(51) Int. Cl. H04Q 7/20

(52) U.S. Cl. 455/517; 370/338

(57) ABSTRACT

The present mobile wireless local area network system for automating fleet operations creates a short-range wireless local area network (wireless LAN) on a transportation vehicle, such as a: trailer, container, railroad car, ship, or the like. The mobile wireless LAN couples data to a LAN hub from a plurality of wireless sensors that are placed in various locations on the transportation vehicle and on the cargo that is contained in the transportation vehicle. The collected data represents various environmental and functional measurements associated with the transportation vehicle and the cargo. The mobile wireless LAN travels with the transportation vehicle and can interact with a hub on other compatible wireless LANs or wireless interfaces on the hub of a wireline-based LAN that are within data signal transmission and reception range.

### CROSS-REFERENCE TO RELATED APPLICATIONS

This application has priority based on U.S. Provisional Application Serial No. 60/249,556, filed on Nov. 17, 2000 and titled “Mobile RF Network for Automating Fleet Operations.”

### FIELD OF THE INVENTION

The present invention relates to a system for automating the operations of a fleet of commercial vehicles so that a party in interest can review current data concerning any particular vehicle and its cargo.

### PROBLEM

It is a problem in the field of fleet operations of commercial cargo vehicles that many manual steps are required for the management and tracking of the transport vehicles and their associated cargo. Examples are: logging in at an entry station to allow a driver to determine where to go in a yard or depot; checking cargo against invoices when the cargo is loaded to ensure that it is going to the right destination; checking cargo against invoices when it is off loaded; obtaining route information for the driver before he leaves a depot; communicating information about the state of the cargo (temperature, spoilage, and the like); keying-in driver/owner information at fuel islands and weigh-bridges; checking for proper inflation of tires; and other like items.

In addition to requiring operator/driver/personnel intervention, many of these operations involve the transfer of printed or written information, such as: lists, manifests, invoices, and the like. In all of these operations, there are opportunities for error, fraud, and laxity to negatively affect the timeliness, accuracy, or believability of these events or operations. Losses from these mishaps are a factor in the operating costs of fleets of commercial cargo vehicles. These problems are particularly evident in the case of refrigerated trailers, containers, and rail cars where the goods must be maintained within certain temperature limits. Failure to do so can lead to food safety issues and large insurance claims. Also, in some cases, the contents of a trailer, container, or rail car may stay the same while the tractor, train, ship, or other transportation means may change. Thus, the owner/shipper must rely on the driver or yard personnel to maintain the documentation associated with the cargo, even though these personnel are not employees of the owner/shipper.

There is, therefore, a need in the industry for a system that automatically collects information about cargo, including temperature and other status variables, and that can interact with fixed data bases containing routing, destination, and financial/invoice information. Such a system has a value that can be enhanced with the addition of devices that determine the vehicle position (such as via GPS) and that can obtain other information such as tire pressure and engine data.

Some of the above problems have been the subject of the application of technology to the transportation/distribution chain. For instance, bar codes are routinely used within shipping and distribution centers to speed up the checking of goods in transit. Hand-held bar code readers may either store the data, or, in some cases, transmit them via a short range radio frequency link to a nearby fixed reader that would normally be connected to the local-area-network (LAN), if one exists in the depot or yard. United Parcel Service Corporation uses a hand-held computer device that allows for automatic tracking of information. This device is carried by the driver and performs multiple functions, including recording the signatures of the parties who receive deliveries. This device has a radio data link that allows the information to be communicated back to a central point and placed on a network. In addition, U.S. Pat. No. 5,552,789 discloses the use of radio frequency powered, passive transponders that can be used to monitor various vehicle conditions and that can be activated via a radio frequency signal to identify the vehicle. However, the passive transponders are limited in function and can only respond to a locally generated radio frequency signal since they are powered by the locally generated radio frequency signal. Thus, they can be activated by spurious radio frequency signals, are slave devices connected to the controller on the vehicle, and cannot be queried from a remote location.

### SOLUTION

The present mobile wireless local area network system for automating fleet operations solves the above described problems by creating a short-range wireless local area network (wireless LAN) on a transportation vehicle, such as a: trailer, container, railroad car, ship, or the like. The mobile wireless LAN enables a wireless LAN hub to exchange data with a plurality of wireless nodes, including wireless sensors that are placed in various locations on the transportation vehicle and on the cargo that is contained in the transportation vehicle. The wireless nodes are active devices that perform various control and/or monitoring functions and themselves could be a LAN or part of a LAN. The data collected by the wireless LAN hub can be used to create an electronic record of all vehicle and cargo related data, which electronic record can be shared with a centrally located data processing system operated by the fleet operations manager. The collected data represents various environmental and functional measurements associated with the transportation vehicle and the cargo. The mobile wireless LAN travels with the transportation vehicle and can interact with a hub on other compatible wireless LANs or wireless interfaces on the hub of a wireline-based LAN that are within data signal transmission and reception range. Thus, the mobile wireless LAN is part of a larger LAN that is used to communicate with a plurality of mobile wireless LANs that are located on transportation vehicles operated by the fleet operator. When various ones of the mobile wireless LANs are out of communication with the remainder of the larger LAN, communications can be effected via cellular, satellite, pager, or the like.

For example, when the mobile wireless LAN is within range of a hub that is part of a fixed LAN, the transportation vehicle can communicate with a wireless interface on this hub of the fixed LAN and thereby appear as one or more nodes on the fixed LAN. The mobile wireless LAN can exchange data with the fixed LAN, such as uploading identification data and the collected sensor data and receiving data, such as routing and/or cargo data. The mobile wireless LAN can also transmit the collected sensor data to a hub of a remote wireless LAN (or a remote wireline-based LAN equipped with a wireless communication interface) that is within communication distance of the transportation vehicle. The mobile wireless LAN can also receive data from the remote wireless LAN. For instance, if the transportation vehicle is within a freight depot, its mobile wireless LAN hub could connect with a fixed “gate” reader to become part of the remote wireless LAN while it is located within the freight depot for the exchange of information.

For those occasions when the mobile wireless LAN is out of range of communication with compatible wireless or fixed LAN nodes, a long-range “back haul” connection, such as: cellular, cellular digital packet data, satellite, 2-way paging and the like, may be used to communicate with a selected destination. The selected destination can be a hub on a wireless LAN node or a fixed LAN node or the destination can be a remote fixed location that may be connected to a conventional LAN in the owner/operator/shipper premises. Thus, the mobile wireless LAN, while traveling with the transportation vehicle, can interact with other compatible wireless LANs.

### BRIEF DESCRIPTION OF THE DRAWINGS

FIG. 1 is a diagram of a typical transportation vehicle that is equipped with the present mobile wireless local area network system for automating fleet operations;

FIG. 2 is a diagram of a typical transportation vehicle that is equipped with the present mobile wireless local area network system for automating fleet operations while proximate to a loading/unloading dock that is equipped with a wireless LAN; and

FIG. 3 is a block diagram of wireless communication between a typical transport vehicle that is equipped with the present mobile wireless local area network system for automating fleet operations and a remote receiving station.

### DETAILED DESCRIPTION OF THE DRAWINGS

The present mobile wireless local area network system for automating fleet operations creates a short-range wireless local area network (wireless LAN) on a transportation vehicle, such as a: trailer, container, railroad car, ship, or the like. The mobile wireless LAN couples sensor data to a wireless LAN hub from a plurality of wireless sensors that are placed in various locations on the transportation vehicle and on the cargo that is contained in the transportation vehicle. The collected sensor data represents various environmental and functional measurements associated with the transportation vehicle and the cargo. The mobile wireless LAN travels with the transportation vehicle and can interact with a hub on other compatible fixed wireless LANs or wireless interfaces on the hub of a wireline-based LAN that are within data signal transmission and reception range.

Transportation Vehicle Implementation of the Mobile Wireless LAN

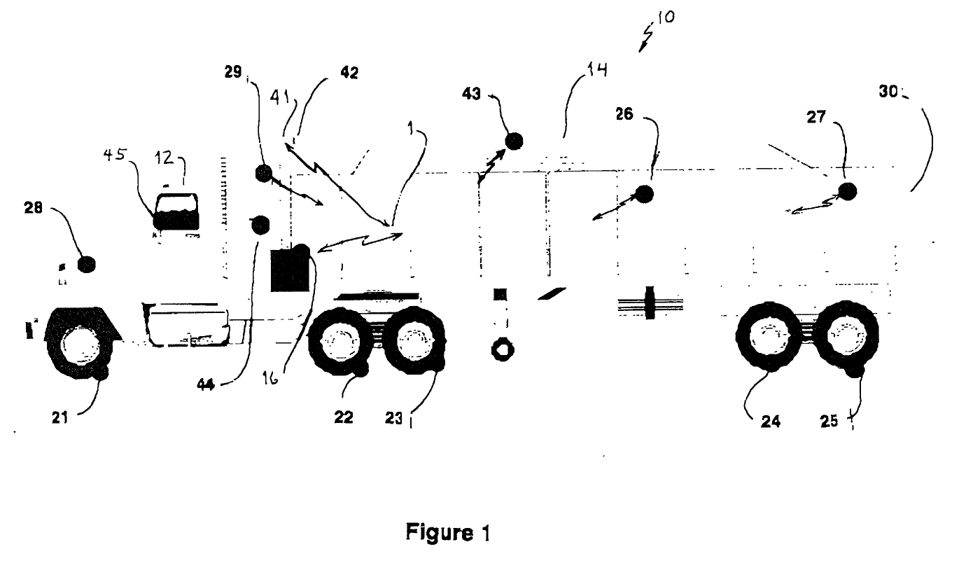

FIG. 1 is a diagram of a typical transportation vehicle 10, in the form of an 18-wheel semi-truck and trailer, which is equipped with the present mobile wireless local area network system 1 for automating fleet operations. The transportation vehicle 10 could alternatively be a ship at sea, a train, or any other type of vehicle including containers, trailers, railroad cars, and the like. In this embodiment, the transportation vehicle 10 has a cab 12 pulling a trailer 14. The cab 12 and trailer 14 have a plurality of wireless sensor nodes 21-30 for generating sensor data signals representing a plurality of functions and environmental conditions associated with the transportation vehicle 10 and its cargo. The plurality of sensors 21-30 is coupled to a short-range wireless LAN hub 16 that is shown as located in trailer 14, although the wireless LAN hub 16 could alternatively be mounted in cab 12.

The sensor data that is transmitted to a fixed wireless LAN may include many different types of information, not only about the transportation vehicle 10, but also about the cargo. This information may include, but is not limited to, temperature of the cargo, identification of the individual cargo units, vehicle doors being opened and closed, vehicle tire pressure and temperature, and engine data such as RPM, temperature, and the like.

As can be seen, the wireless sensors 21-29 include tire pressure and/or tire temperature sensors 21-25, cargo temperature sensor 26, and chemical/radiation sensor 27. Other wireless sensors can also be installed on the transportation vehicle 10 to detect and generate sensor data signals representing any other desired function such as: engine data 28, refrigeration unit controller interface 29, door position/locked status 30, and the like. Wireless LAN hub 16 uses a radio device 41 and its associated antenna 42 installed on the trailer 14 to create the short-range wireless LAN that receives wireless sensor data from the wireless sensors 21-30 at the various nodes mentioned above. In addition, a Global Positioning System receiver 43 can be used to obtain precise location information.

The mobile wireless LAN 1 is also coupled to the wireless LAN hub 16 through any acceptable coupler, such as T-Bridge™ equipment (a telemetry bridge) manufactured by CrossLink, Inc which communicates with inexpensive tags at ranges of up to several hundred feet. Power for this “wired” portion of the equipment could typically come from the electrical system of the refrigeration unit. Alternatively, power could come from primary batteries or from solar cells and rechargeable batteries. The wireless LAN hub 16 with associated software is at the heart of the unit. The sensor data relating to the various detected and monitored functions are transmitted to the wireless LAN hub 16, where the data is stored. The wireless LAN hub 16 also maintains a list of wireless system components associated with it and can communicate with them by means of unique addresses. This allows the wireless LAN hub 16 to ignore wireless components that may be on another trailer in close enough proximity to allow them to be accidentally read.

The sensor data so stored can be uploaded to a destination data storage system on command, during emergencies, or at programmed time intervals as is described below, using along-range back-haul system, such as satellite communicator 44. This satellite communicator 44 can be the Wwwhisper Controller produced by CrossLink, Inc. of Boulder, Colo. The long-range back-haul system could also be a 2-way paging system, or alternatively, a Satellite Modem. The long-haul backup controller invokes such communications to collect data and manage messages when the vehicle is out of range of the fixed wireless LAN. The mobile wireless LAN 1 can also connect to fixed gate or entry station readers that are in range and that may be connected to an existing wired LAN.

A terminal device, such as in-cab display 45 is typically located in each transportation vehicle 10, such as in the vehicle cab 12, and is used to display such information as the driver may require including routes, destinations, and information about the cargo. The driver can also input information via this in-cab display 45 which is brought back to the mobile wireless LAN hub 16 on the transportation vehicle 10 for transmission to fixed wireless LAN nodes. Wireless sensors can be placed on or in the trailer 14 to monitor the temperature 26, presence of chemicals/radiation 27, status of doors (open/closed) 30, or other parameters. The presence of chemicals/radiation includes the presence of gases (e.g. ethylene, indicative of spoilage), Carbon Monoxide indicative of an exhaust leak, detection of explosives, detection of hazardous chemicals, and the like. A refrigeration unit controller interface 29 may be used to couple the refrigeration unit to the mobile wireless LAN 1 so that the operation and status of the refrigeration unit can be monitored and controlled.

The mobile wireless LAN 1 may have an interface 28 with the transportation vehicle data bus to monitor the transportation vehicle engine. This would allow the mobile wireless LAN 1 to monitor towing vehicle operations and would be particularly useful, with a long-range back haul link, to alert a remote site that the vehicle tractor is experiencing off-nominal conditions. Such information could also be passed on to the driver via the in-cab display 45.

Typical Sensors

The wireless sensors 21-30 can either be T-Bridge™ temperature tags or straightforward derivatives of them. Similarly, a T-Bridge™ could easily be interfaced to a refrigeration unit controller or a vehicle engine management database. The T-Bridge™ wireless LAN hub 16 can connect, one at a time, with the other wireless components and transmit data to them or receive data from them. In addition, the sensors can be active devices that can be programmed via the use of the mobile wireless LAN 1. For example, temperature limits for the cargo area can be set so the sensor can autonomously generate an alarm when the ambient temperature exceeds the preset limit to indicate that the cargo is at risk. Furthermore, the mobile wireless LAN, operating independently or in conjunction with the overall network, can perform audits to ensure that the cargo loaded in the trailer 14, as detected by the operation of cargo sensors or bar code readers matches the expected cargo. The communications among the sensors and the wireless LAN hub 16 and the other nodes on the network are bi-directional, and can be initiated by the sensors when an anomaly is detected.

Wireless sensors 21-25 mounted inside the air chamber of the tires of the transportation vehicle 10 can report tire pressure and temperature to the mobile wireless LAN 1 for further action such a routing to the long-range back haul link as described below or to the display on the in-cab message display terminal 44. Sensors, for example acoustic or optical beam type sensors (not shown), can be used to estimate how full the cargo compartment is, and transmit this information to the mobile wireless LAN 1. Sensors that measure the mechanical conditions of the transportation vehicle 10 or cargo, such as vibration or shock can be placed on the mobile wireless LAN 1.

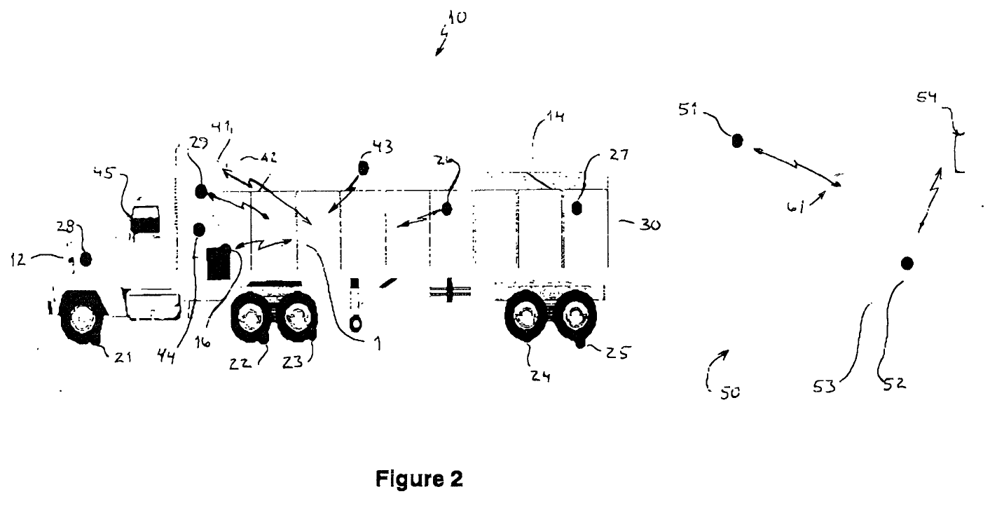

In addition, a GPS receiver 41 may form part of the transportation vehicle equipment so that the transportation vehicle position and time in that position may be determined. When the transportation vehicle 10 is out of range of direct transmission between the mobile wireless LAN 1 to the fixed wireless LAN, the mobile wireless LAN data can be transmitted by a long-range back haul unit to the desired fixed wireless LAN. Thus, the data transmitted can be cargo information, vehicle data, and transportation vehicle location at any given time. If the mobile wireless LAN 1 is out of wireless communication range of the fixed wireless LAN 54, the mobile wireless LAN 1 has its output coupled to the wwwhisper satellite communicator 30 which is a long-range “back haul” device such as a cellular connection, CDPD (cellular digital packet data), satellite, 2-way paging, and the like) to a remote fixed location that is connected to the fixed wireless LAN 54 (shown in FIG. 2) at a location such as at the owner/operator/shipper premises. The mobile wireless LAN 1 travels with the transportation vehicle 10 and interacts with other compatible wireless LAN nodes that may take a number of different forms such as:

Fixed readers (such as 51 shown in FIG. 2) at entry stations, gates, guard shacks, and the like are coupled to the fixed wireless LAN 22. On entering an area, such readers allow for the authorization for admittance to the area, notification of the shipper that the cargo has arrived, and like information. On leaving the area, the fixed wireless LAN 54 allows for checking that the cargo is authorized to leave (theft prevention), downloading of route/delivery/destination information, and alerting the shipper that goods have left the area. FIG. 2 is a diagrammatic representation of a transportation vehicle 10 in the form of an 18 wheel semi-truck & trailer in proximity to a loading dock 50 for receiving and/or unloading cargo. The loading dock illustrates a palette 53 having a wireless sensor 52 thereon that could be, for example, a temperature sensor.

Hand-held bar-code readers (not shown) may be used by the driver or by depot/yard personnel to scan individual cargo items as they are loaded or unloaded, allowing for automatic updating of the manifest and reconciliation with invoices, and the like. This information can be returned via the long-range “back haul” connection to a fixed wireless LAN 54 when the transportation vehicle 10 is out-of-range of direct communication from the mobile wireless LAN 1 to the fixed wireless LAN 54 at a fixed location.

Radio Frequency Identification (RFID) devices (not shown) such as badge/proximity/EAS readers may be used to track cargo, authorize admittance to the trailer, or for other purposes related to managing cargo.

Automatic door locks 30 may utilize a T-bridge tag that can be readily adapted to control any electronic/electromagnetic door locks. By interfacing to the back-haul link, the door on the trailer 14 may be opened only after a remote operator has verified that this is permissible. The link could be used for a number of purposes, including insurance verification.

Mobile Wireless LAN Interconnected With a Fixed Wireless LAN

FIG. 2 is a diagram of a typical transportation vehicle 10 that is equipped with the present mobile wireless local area network system for automating fleet operations while proximate to a loading/unloading dock that is equipped with a wireless LAN that comprises a part of the overall wireless local area network. The above-noted sensor data are transmitted to a destination, such as the fixed wireless LAN 54 shown in FIG. 2.

Fixed location data readers 51 at entry stations, gates, guard shacks, and the like are typically provided in conjunction with the operation of the freight yard. Thus, when the transportation vehicle 10 arrives at an area, the transportation vehicle 10 may be authorized to enter, the driver can be notified as to where to go in the area, the shipper can be notified that the cargo has arrived, and like information can be transmitted to and from the mobile wireless LAN 1 located on the transportation vehicle 10. During this time, the nodes on the transportation vehicle's mobile wireless LAN 1 became nodes on the fixed wireless LAN 54 at the facility the transportation vehicle 10 is attending. On leaving an area, the transportation vehicle cargo can be checked and authorized to leave the area (theft prevention), route/delivery/destination information can be downloaded, and the shipper can be alerted that the designated cargo (goods) have left the area.

Back Haul Mode of Operation of the Mobile Wireless LAN

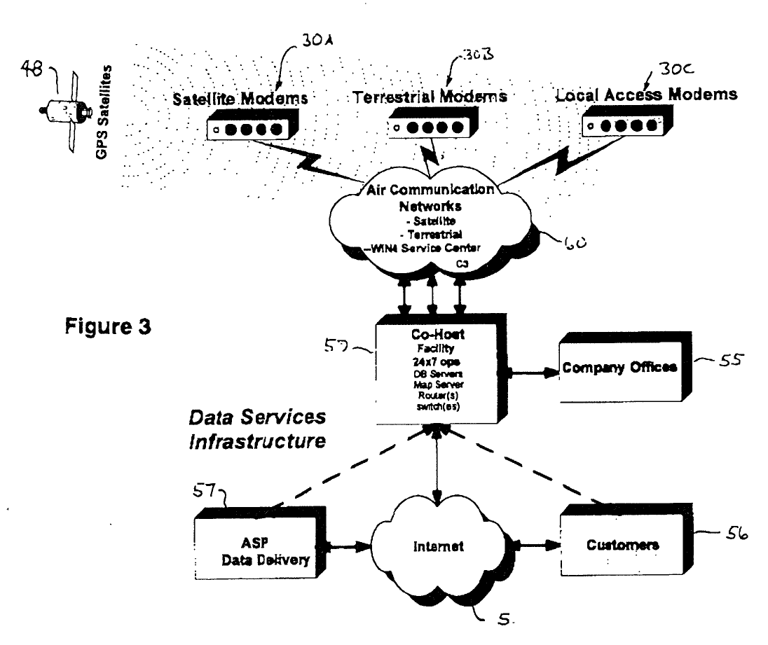

The long-range back haul data is typically delivered to the user via the Internet. It contains the GPS data and so may be shown on a map display. FIG. 3 is a diagrammatic representation of wireless communication between the mobile wireless local area network system for automating fleet operations as installed on a transportation vehicle 10 and a remote receiving station and, in particular, the use of the wwwhisper communication system 44. As shown in FIG. 3, the wireless LAN hub 16 in FIG. 1 can be a global unit (satellite modem 30a), a national unit (terrestrial modem 30b), and/or a city unit (local access modem 30c). The city unit 30c uses the mobile wireless LAN 1 on the transportation vehicle 10 to directly communicate with a fixed wireless LAN 54 (also shown in FIG. 2) as a transportation vehicle 10 moves within a city. Any wireless communication network type could be used. The city unit 30a can also receive GPS signals from GPS satellite 48 and using a GPS receiver 43 as well known in the art, can provide data regarding the position of the transportation vehicle 10 as well as the time the transportation vehicle 10 is at any position.

The global and national units 30a and 30b are “back haul” long-range units that use any type of RF signal and the associated air communication network 60 to communicate. with the fixed wireless LAN 59 at a fixed location. They can also receive GPS signals from the GPS satellite 48 to provide data regarding the position of the transportation vehicle 10 around the nation and around the globe.

From the fixed wireless LAN 59, the received signals can be sent directly to a wireline-based LAN at the customer site 56 or the operator/owner site 55 where the information can be displayed. In addition, it can be sent via an Internet Service Provider through the Internet 54 to the operator/owner site 55 or to a customer site 56 or can be transmitted by any other available communication means 57 to the Internet 54.

Thus, there has been disclosed a novel mobile wireless local area network system for automating fleet operations using a radio device installed on a transportation vehicle that creates a short-range wireless local area network (wireless LAN) and carries the LAN with it. This network is capable of communicating with a fixed location receiver remote from the vehicle and that can be connected to a conventional wireless LAN in the owner/shipper/operator premises. Since it travels with the vehicle, the created wireless LAN can communicate with any compatible wireless LAN nodes such as fixed readers, handheld bar-code readers, RFID readers, wireless sensors of various components, and interface units for automatic door locks, display terminals, refrigeration units, and vehicle engine components.

The mobile wireless local area network system for automating fleet operations can also use a transmission system having a long-range back haul modem of various types to communicate with compatible receivers at fixed locations. This option is typically selected when the transportation vehicle is out of range of direct transmission from the wireless LAN to the remote receiver that could be a wireless LAN or could be connected to a wireless LAN at the customer facility.

Summary

While the mobile wireless local area network system for automating fleet operations has been disclosed in connection with a preferred embodiment, it is not intended to limit the scope of the invention to the particular form set forth, but, on the contrary, it is intended to cover such alternatives, modifications, and equivalents as may be included within the spirit and scope of the invention as defined by the appended claims.

What is claimed:

1. A mobile wireless LAN system for automating transportation fleet operations, mounted on a transportation vehicle, comprising:
a plurality of wireless nodes;
a wireless LAN located on said transportation vehicle for exchanging communications among said plurality of wireless nodes; and
wherein said plurality of wireless nodes includes a plurality of wireless sensors for detecting a plurality of functions associated with at least one of: said transportation vehicle and a cargo transported by said transportation vehicle and for generating wireless sensor data representative of said detected plurality of functions associated with at least one of: said transportation vehicle and a cargo transported by said transportation vehicle.

2. The mobile wireless LAN system of claim 1 further comprising:
a hub connected to and serving said wireless LAN for managing the exchange of said data, including said wireless sensor data, among said plurality of wireless nodes and said hub.

3. The mobile wireless LAN system of claim 2 further comprising:
a wireless transceiver connected to said wireless LAN for exchanging data, including said wireless sensor data, with a wireless transceiver at a fixed location removed from said transportation vehicle.

4. The mobile wireless LAN system of claim 3 further comprising:
at least one fixed LAN, including a wireless transceiver, at a fixed location for receiving said transmitted wireless sensor data from said wireless transceiver located on said transportation vehicle.

5. The mobile wireless LAN system of claim 4 further comprising:
a GPS receiver located on said transportation vehicle for receiving GPS position and time signals; and
a long-range signal transmission system located on said transportation vehicle coupled to said GPS receiver and to said wireless LAN for exchanging data, including said GPS signals and said wireless LAN sensor data, with said at least one fixed LAN at said fixed location.

6. The mobile wireless LAN system of claim 1 further comprising:
at least one display unit coupled to said wireless LAN for displaying said wireless sensor data.

7. The mobile wireless LAN system of claim 1 wherein said plurality of wireless sensors on said transportation vehicle comprise at least one of the class of environmental sensors comprising:
a wireless sensor for measuring tire pressure and temperature;
a wireless sensor for measuring cargo temperature;
a wireless sensor for detecting when vehicle cargo doors are opened/closed;
at least one wireless sensor for measuring engine component functions;
a wireless sensor coupled to a refrigeration unit mounted on said transport vehicle for transmitting refrigerator function data to said wireless LAN for transmission.

8. The mobile wireless LAN system of claim 1 further comprising at least one data reader from the class of fixed location data readers comprising:
at least one fixed gateway data reader at locations including at least one of: entry stations, gates, guard shacks, and loading docks for receiving transmissions from said wireless LAN on said transportation vehicle;
at least one hand-held bar-code reader to be used by either the driver or personnel at said fixed location to scan individual bar-coded cargo items for purposes of tracking cargo
at least one RFID reader as an automatic-data-capture device for tracking cargo, personnel, and managing cargo.

9. The mobile wireless LAN system of claim 1 further comprising:
electronic/electromagnetic door locks on said transportation vehicle doors; and
a telemetry tag adapted to control said door locks to both enable and disable said door locks from said fixed location remote from said transportation vehicle.

10. A method of operating a mobile wireless LAN system for automating transportation fleet operations, mounted on a transportation vehicle and including a plurality of wireless nodes, comprising the steps of:
exchanging communications among said plurality of wireless nodes using a wireless LAN located on said transportation vehicle; and
detecting a plurality of functions associated with at least one of: said transportation vehicle and a cargo transported by said transportation vehicle using a plurality of wireless sensors; and
generating wireless sensor data representative of said detected plurality of functions associated with at least one of: said transportation vehicle and a cargo transported by said transportation vehicle.

11. The method of operating a mobile wireless LAN system of claim 10 further comprising the step of:
managing the exchange of said data, including said wireless sensor data, among said plurality of wireless nodes and a hub connected to said wireless LAN.

12. The method of operating a mobile wireless LAN system of claim 11 further comprising the step of:
exchanging, using a wireless transceiver connected to said wireless LAN, data, including said wireless sensor data, with a wireless transceiver at a fixed location removed from said transportation vehicle.

13. The method of operating a mobile wireless LAN system of claim 12 further comprising the step of:
receiving, at least one fixed LAN, said transmitted wireless sensor data from said wireless transceiver located on said transportation vehicle.

14. The method of operating a mobile wireless LAN system of claim 13 further comprising the steps of:
receiving, via a GPS receiver located on said transportation vehicle, GPS position and time signals; and
exchanging, via a long-range signal transmission system located on said transportation vehicle coupled to said GPS receiver and to said wireless LAN, data, including said GPS signals and said wireless LAN sensor data, with said at least one fixed LAN at said fixed location.

15. The method of operating a mobile wireless LAN system of claim 10 further comprising the step of:
displaying, via at least one display unit coupled to said wireless LAN, said wireless sensor data.

16. The method of operating a mobile wireless LAN system of claim 10 wherein said plurality of wireless sensors on said transportation vehicle comprise at least one of the class of environmental sensors, comprising:
a wireless sensor for measuring tire pressure and temperature;
a wireless sensor for measuring cargo temperature;
a wireless sensor for detecting when vehicle cargo doors are opened/closed;
at least one wireless sensor for measuring engine component functions;
a wireless sensor coupled to a refrigeration unit mounted on said transport vehicle for transmitting refrigerator function data to said wireless LAN for transmission.

17. The method of operating a mobile wireless LAN system of claim 10 further comprising at least one data reader from the class of fixed location data readers comprising:
at least one fixed gateway data reader at locations including at least one of: entry stations, gates, guard shacks, and loading docks for receiving transmissions from said wireless LAN on said transportation vehicle;
at least one hand-held bar-code reader to be used by either the driver or personnel at said fixed location to scan individual bar-coded cargo items for purposes of tracking cargo
at least one RFID reader as an automatic-data-capture device for tracking cargo, personnel, and managing cargo.

18. The method of operating a mobile wireless LAN system of claim 10 further comprising:
operating electronic/electromagnetic door locks on said transportation vehicle doors; and
using a telemetry tag adapted to control said door locks to both enable and disable said door locks from said fixed location remote from said transportation vehicle.
